(19) United States
(12) Patent Application Publication
(10) Pub. No.: US 2017/0169671 A1
(43) Pub. Date: Jun. 15, 2017

(54) COMPUTER IMPLEMENTED SYSTEM AND METHOD FOR DETERMINING SEAT OCCUPANCY AND GUIDING USERS TO PREFERABLE SEATS IN A DEFINED SPACE

(71) Applicant: Lakshya Pawan Shyam KAURA, Haryana (IN)

(72) Inventor: Lakshya Pawan Shyam KAURA, Haryana (IN)

(21) Appl. No.: 15/377,045

(22) Filed: Dec. 13, 2016

(30) Foreign Application Priority Data
Dec. 15, 2015 (IN) 3480/DEL/2015
Dec. 15, 2015 (IN) 3481/DEL/2015

(51) Int. Cl. G08B 5/22; G01C 21/20; G01C 21/00

(52) U.S. Cl. CPC G08B 5/221; G01C 21/005; G01C 21/206

(57) ABSTRACT

A system and method for determining seat occupancy and guiding users to preferable seats in a defined space are described herein. The system comprises a plurality of load cells, wherein each of the load cells is attached to a seat to detect a weight, a repository to store a predetermined set of rules, a predetermined load value and a seat occupancy map, a first comparator configured to compares the signals generated by the load cells with a predetermined load value to determine the occupied seats. A second comparator is configured to identify seats that ought to have been occupied, based on the determined occupied seats and stored pre-determined seat occupied seat. Further, the system comprises a display to display the occupied seats and the unoccupied seats that ought to have been occupied. The input module accepts from the user with the help of the handheld device, a preferable seat from the displayed map. The seat locator identifies location of the preferable seat on the map and the user locator identifies location of the user. The path identifier then identifies a path from the user location to the preferable seat and the navigator navigates the user to follow the path to reach the preferable seat.

### TECHINCAL FIELD

The present disclosure relates to the field of determining seat occupancy and guiding users to preferable seats.

### BACKGROUND

Conventionally, a host of an event or a driver of a transport vehicle makes sure that attendees/customers/passengers are seated at their respective reserved seats, before commencement of the event/journey. In case where when a large number of passengers need to board the transport vehicle, it becomes difficult for a driver/host to make sure that all the passengers have boarded. It is also difficult to determine whether the passengers are seated at their respective reserved seats. Consequently, judgment of the driver/host with respect to presence of all the passengers and whether the passengers are seated at their respective seats is susceptible to error. This process is also time consuming. In case of a long journey, the transport vehicle tends to have intermediary stops, and in such cases, the driver/host has to make sure whether the passengers who had alighted the vehicle, have re-boarded the vehicle and are again seated at their respective reserved seats. These intermediary stops also act as disembarking/boarding points for some of the passengers. In such cases, the driver/host has to make sure whether the passenger has correctly disembarked or boarded the vehicle.

In another example, when a customer/attendee electronically purchases tickets to attend events at a venue, but he has not previously visited the venue or a particular section, the customer/attendee may be confused when he actually arrives at the venue. The customer/attendee may fail to reach at a preferred seat on time because of the confusion and delay caused in locating the seat. Moreover, this leads to a commotion at the venue if the venue is a theatre or a cinema hall where audience is already settled and the event has begun.

The judgment or determination of the host/driver is susceptible to human errors. Further, the attendees/customers fail to reach at a preferred seat on time because of confusion and delay in locating their seats. Therefore, there is a need of a system which limits the aforementioned drawbacks and provides a system for determining seat occupancy and providing guidance to users to reach preferable seats in a defined space.

### OBJECTS

Some of the objects of the present disclosure aimed to ameliorate one or more problems of the prior art or to at least provide a useful alternative are listed herein below.

An object of the present disclosure is to provide a system for determining seat occupancy and guiding users to preferable seats in a defined space.

Another object of the present disclosure is to provide a system through which a host can determine seat occupancy.

Another object of the present disclosure is to provide a system which eliminates human errors while determining the seat occupancy.

Yet another object of the present disclosure is to provide a system for guiding users to seats by paths having less obstacles.

Still another object of the present disclosure is to provide a system for guiding users to seats with the help of handheld devices.

Other objects and advantages of the present disclosure will be more apparent from the following description when read in conjunction with the accompanying figures, which are not intended to limit the scope of the present disclosure.

### SUMMARY

The present disclosure envisages a system and method for determining seat occupancy and guiding users to preferable seats in a defined space. The system comprises an associator, a repository, a processor, a plurality of load cells, an amplifier, an analog to digital converter, a first comparator, a second comparator, a display, an input module, a seat locator, a user locator, a path identifier, and a navigator. The associator is configured to associate a handheld device of a user to the system. The repository is configured to store a predetermined set of rules, a predetermined load value and a pre-determined seat occupancy map of the defined space. The processor is configured to cooperate with the repository to receive the predetermined set of rules and possess functional elements to provide system processing commands. The plurality of load cells are configured detect a weight and generate output signals based on the detected weight, wherein a load cell is connected to each seat. The amplifier is configured to cooperate with the load cells to respectively receive and amplify corresponding output signals to obtain amplified signals. The analog to digital converter is configured to cooperate with the processor and the amplifier, to respectively receive the amplified signals and convert into digital signals. The first comparator is configured to cooperate with the processor and the analog to digital signals, and configured to compare values in the digital signals with the stored pre-determined load value to determine the occupied seats. The second comparator is adapted to cooperate with the repository and the first comparator, and is configured identify the unoccupied seats that ought to have been occupied based on the determined occupied seats and stored pre-determined occupancy map. The display is configured to cooperate with the first comparator and the second comparator to display a seat occupancy map showing the occupied seats and the unoccupied seats that ought to have been occupied. The input module cooperates with the display and the handheld device to accept from the user a preferable seat from the displayed seat occupancy map. The seat locator then identifies location of the preferable seat based on the stored pre-determined seat occupancy map and the user locator identifies location of the user with the help of the handheld device. Based on the identified locations, the path identifier identifies at least one path from the location of the user to the location of the preferable seat and the navigator navigates the user with the help of the handheld device to follow the path to reach to the preferable seat.

In another embodiment, the load cells are selected from a group of load cells consisting of strain gauge load ells and piezoelectric load cells.

Further, in an embodiment, the seat locator identifies an unoccupied seat from the stored seat occupancy map such that location of the identified unoccupied seat is proximal to a user location and a path from the user location to the location of the unoccupied seat has less obstacles.

Furthermore, the path identifier identifies a path such that it has less obstacles. Additionally, the seat occupancy map includes occupied seats and unoccupied seats, such that the occupied seats are displayed with different indicia than the unoccupied seats.

In one embodiment, the system includes at least one indicator configured to indicate when all seats are occupied and/or unoccupied.

In another embodiment, the repository further stores a seat reservation map, to provide indication when the seat occupancy map does not match the seat reservation map.

This summary is provided to introduce concepts related to the computer implemented system for determining seat occupancy and guiding users with handheld devices to preferable seats in a defined space, which is further described below in the detailed description. This summary is neither intended to identify essential features of the present disclosure nor is it intended for use in determining or limiting the scope of the present disclosure.

### BRIEF DESCRIPTION OF ACCOMPANYING DRAWING

The system and method of the present disclosure will now be described with the help of the non-limiting accompanying drawing, in which:

FIG. 1 illustrates a schematic diagram of a computer implemented system for determining seat occupancy and guiding users to preferable seats in a defined space, in accordance with an embodiment of the present disclosure;

FIG. 2 illustrates a representation of a display screen of the system of FIG. 1, in accordance with one embodiment of the present disclosure; and

FIG. 3 illustrates a flow diagram showing the steps involved in determining seat occupancy and guiding users with handheld devices to preferable seats in a defined space, in accordance with an embodiment of the present disclosure.

### DETAILED DESCRIPTION

The system of the present disclosure will now be described with reference to the embodiment shown in the accompanying drawing. The embodiment does not limit the scope and ambit of the disclosure. The description relates purely to the example and the preferred embodiment of the disclosed system and its suggested application.

The system and the various features and advantageous details thereof are explained with reference to the non-limiting embodiment in the following description. Descriptions of well-known parameters and processing techniques are omitted so as to not unnecessarily obscure the embodiment herein. The examples used herein are intended merely to facilitate an understanding of ways in which the embodiment herein may be practiced and to further enable those of skill in the art to practice the embodiment herein. Accordingly, the examples should not be construed as limiting the scope of the embodiment herein.

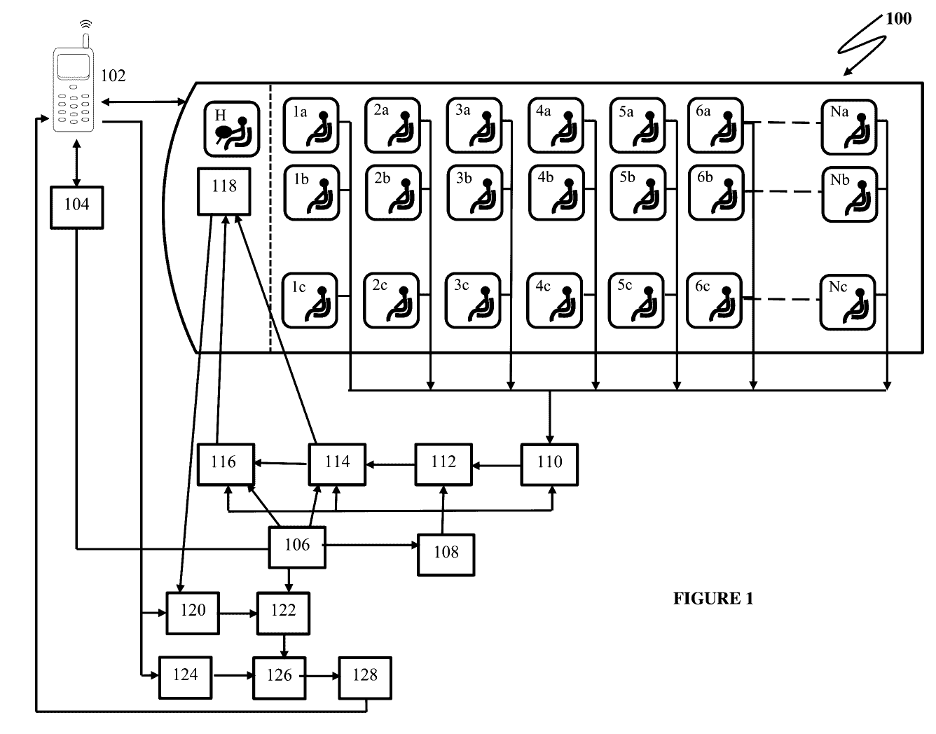

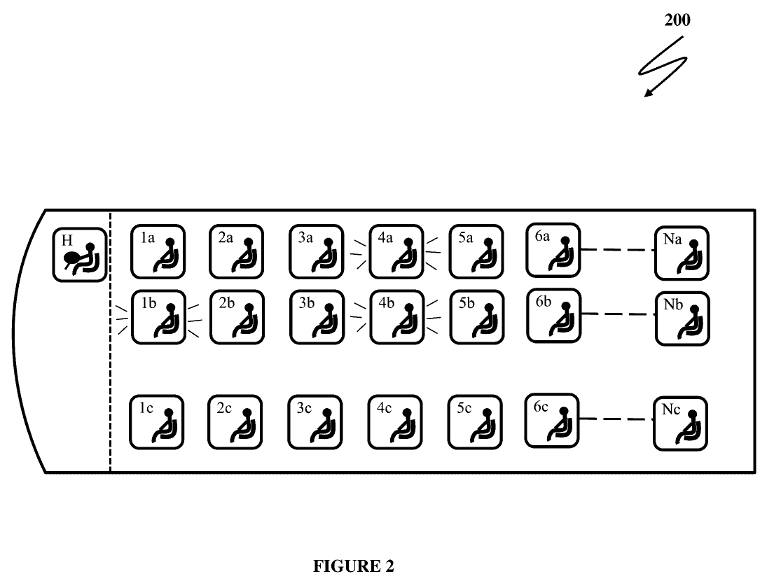

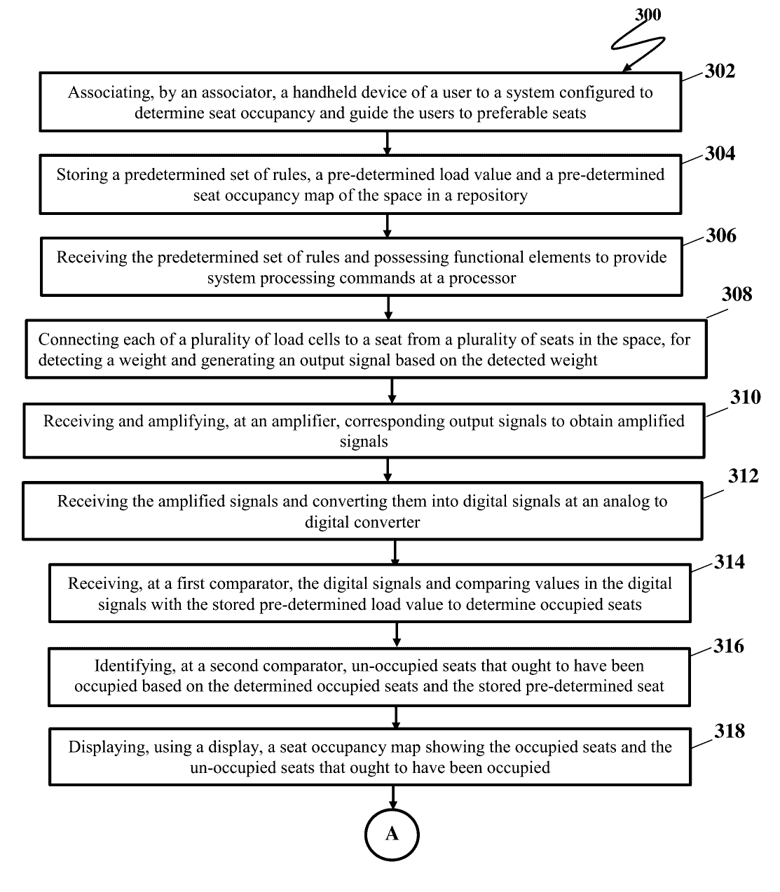

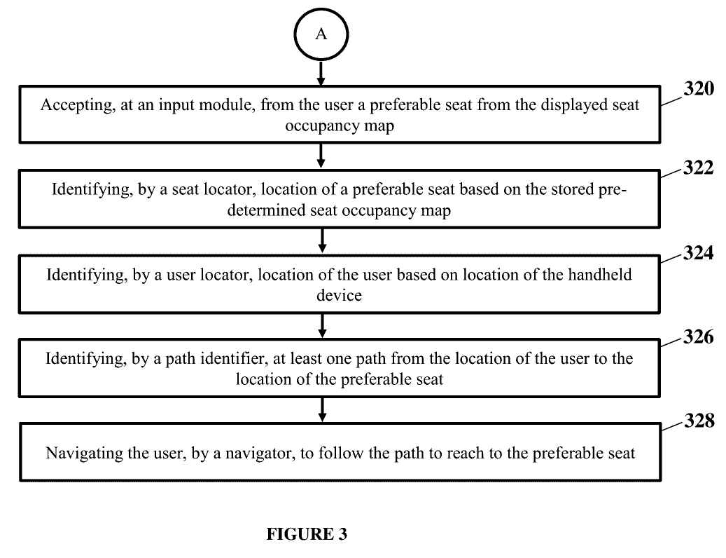

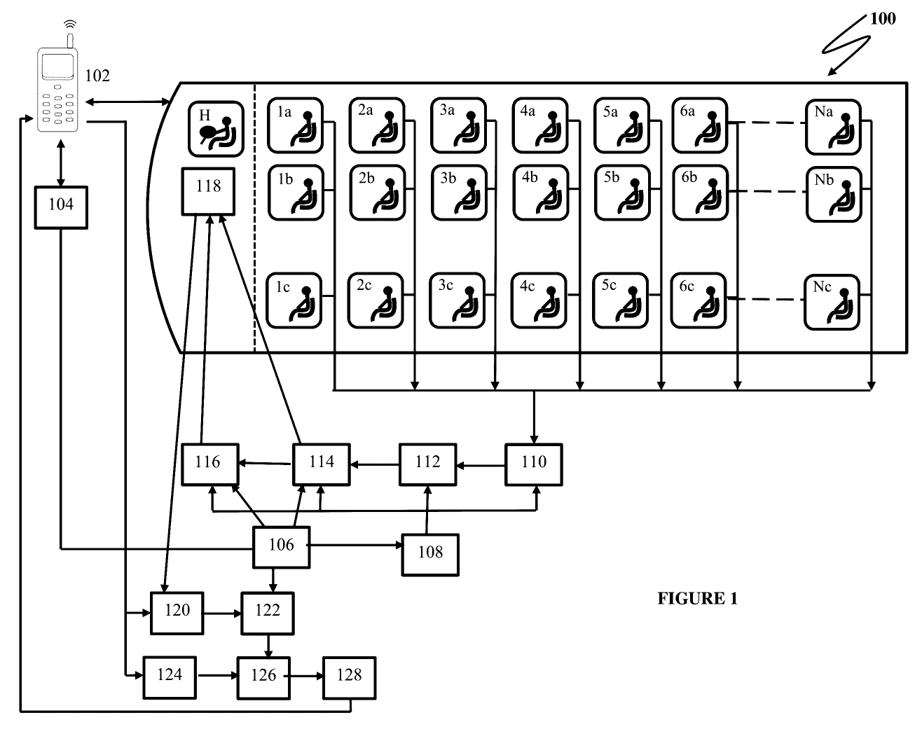

In order to limit previously mentioned drawbacks, the present disclosure envisages a system and method that determines seat occupancy and guides users to desired/preferred seats with the help of handheld devices of the users in a defined space. Referring to the accompanying drawing, FIG. 1 illustrates a system 100 for determining seat occupancy and guiding users with handheld devices 102 to preferable seats. In one embodiment, users refer to consumers using the system 100 and/or audience members that are in the proximity of the defined space. The defined space can be any enclosed space or an open space with seating arrangement. In one embodiment, the defined space is a theatre/cinema hall, a space in transport vehicle, classrooms, lecture halls, auditoriums, and the like.

The system 100 comprises an associator 104, a repository 106, a processor 108, a plurality of load cells (not shown in Figure), an amplifier 110, an analog to digital converter 112, a first comparator 114, a second comparator 116, a display 118, an input module 120, a seat locator 122, a user locator 124, a path identifier 126, and a navigator 128.

In order to determine seat occupancy and guide a user to reach a specific seat placed in the defined space, an associator 104 present in the system 100 associates a handheld device 102 of a user to the system 100. The handheld device 102 can be any of a cellular phone, PDA, tablet, phablet and smartphone that is in possession of the user. Once the system 100 is associated with the handheld device 102 it can navigate the user to reach a specific seat by using a display of the handheld device 102 and/or audio output of the handheld device 102. The structure of the associator 104 in one embodiment includes at least one transceiver which transmits and receives signals to and from the handheld device 102.

The repository 106 is configured to store a pre-determined set of rules, a pre-determined load value and a pre-determined seat occupancy map of the defined space. The repository 106 can include any data storage medium which is known in the art such as volatile memory (e.g. RAM), non-volatile memory (e.g., EPROM, flash memory, etc.) and the like. The predetermined load value is the value of the weight which helps to differentiate between an adult person, an adolescent and a piece of luggage. The seat occupancy map contains the information regarding the occupied/reserved seats opted by the users. In an embodiment, the seat occupancy map is updated before commencement of every journey and/or event. In another embodiment, the seat occupancy map is updated in real-time based on the occupied and unoccupied seats placed in the defined space. In one embodiment, the seat occupancy map is a map which is based on sold tickets and available tickets, where seats corresponding to the sold tickets are displayed as occupied/sold seats and remaining seats are displayed as unoccupied/available seats. In another embodiment, the structure of the repository 106 includes a receiver and a hardware register. The receiver receives the seat occupancy map(s) from a pre-determined source and the hardware register stores this map(s). The seat occupancy map is stored in the repository 106 unless it is explicitly deleted. The occupied seats are displayed with different indicia than the unoccupied seats. For example, an occupied seat may be indicated with a red colour on the map and the unoccupied seat may be indicated with a green colour. In an embodiment, when the user is in the proximity of the defined space, the system 100 automatically associates with the handheld device 102, for further processing and guidance. A user initiates the association by sending an association request to the system 100. In an embodiment, the repository also stores a seat reservation map that is updated before the commencement of every journey.

A pseudo-code depicting the functionality of selecting a seat in a defined space, in accordance with an embodiment of the present disclosure, is now described.
a) There are N numbers of seats in a defined space.
b) The defined space contains M number of rows, where each row contains 1 to X number of seats.
c) A person ‘A’ entered in the defined space chooses a seat on the basis of following conditions:
   a. if, the entire defined space is empty, then, the ‘A’ occupies seat ‘1’,
   else, ‘A’ chooses at least one unoccupied seat in M
   b. if ‘N’ number of seats are occupied, and the defined space is full, then, ‘A’ chooses ‘0’ seat.
d) Done.

The processor 108 is configured to cooperate with the repository 106 to receive the predetermined set of rules and possessing functional elements to provide system processing commands.

The plurality of load cells (not shown in figure), wherein each load cell is connected to each of the seats (1a, 1b, 1c . . . Na, Nb and Nc), and are configured to detect weight and generate an output signal based on the detected weight. In an embodiment, the load cells are attached at the bottom of the seat (1a, 1b, 1c . . . Na, Nb and Nc). In another embodiment, the load cells are selected from a group of strain gauge load cells, piezoelectric load cells, hydraulic load cells, pneumatic load cells, and the like.

The amplifier 110 is configured to cooperate with the processor 108 and the plurality of load cells, to receive the system processing commands from the processor 108 and the output signal from the plurality of load cells. The amplifier 110 is further configured to amplify the output signals received from the corresponding load cells to obtain amplified signals.

The analog to digital converter 112 is configured to cooperate with the processor 108 and the amplifier 110, to receive the system processing commands from the processor 108 and the amplified signals from the amplifier 110. The analog to digital converter 112 is further configured to convert the received amplified signal into digital signals.

The first comparator 114 is configured to cooperate with the processor 108, the repository 106 and the analog to digital converter 112, to receive the system processing commands from the processor 108, the pre-determined load value from the repository 106 and the digital signals from the analog to digital converter 112. The first comparator 114 is further configured to compare values in digital signals with the stored pre-determined load value to determine occupied seats.

In an embodiment, for avoiding errors while determining the occupied seats, the first comparator 114 uses motion sensors/heat sensors for distinguishing a person from a luggage.

A pseudo-code depicting the functionality of the first comparator 114 that uses motion sensors/heat sensors for distinguishing the person from the luggage, in accordance with an embodiment of the present disclosure, is as follows:
a) Adjust a load limit on a seat using a sensor, is attaches to bottom portion of the seat. The sensor checks whether the temperature rises at particular time interval.
b) When an object placed on the seat, the sensor automatically warms up, and detects heat and movement in the surrounding area by creating a pattern of regularly spaced horizontal and vertical lines based on the rising temperature.
c) If the sensor creates different zones for the pattern, and when the energy levels change rapidly, then the sensor senses that the object placed on the seat is a human body.
d) If the sensor does not detect heat and movement in the surrounding area, then the sensor senses that the object placed on the seat is a solid object (luggage).
e) Done.

The second comparator 116 is configured to cooperate with the processor 108, the repository 106 and the first comparator 114, to receive the system processing commands from the processor 108, the seat occupancy map from the repository 106 and determined occupied seats from the first comparator 114. The second comparator 116 is further configured to identify unoccupied seats that ought to have been occupied, based on the determined occupied seats and the stored pre-determined seat occupancy map. In another embodiment, the seat reservation map is updated real-time, and provides indication when the seat occupancy map does not match the seat reservation map.

A pseudo-code depicting the functionality of the second comparator 116 that identifies unoccupied seats that ought to have been occupied based on the determined occupied seats and the stored pre-determined seat occupancy map, in accordance with an embodiment of the present disclosure, is as follows.
a) There are total numbers of seats ‘T’ in the defined space.
b) Determine the total number of occupied seats, where the seats are occupied by the human body or the solid object (luggage).
c) Determine the seats which are occupied by the human body using the sensors ‘O’.
d) The total number of the unoccupied seat is determined by deducting the occupied seats by the human body from the total number of seats present in the defined space=(T-O).

The display 118 is configured to cooperate with the processor 108, the first comparator 114 and the second comparator 116, to receive the processing commands from the processor 108, the determined occupied seats from the first comparator 114 and the second comparator 116. The display 118 is further configured to display the occupied seats and the unoccupied seats that ought to have been occupied. In an embodiment, the display 118 displays the occupied seats with different indicia than the unoccupied reserved seats that ought to have been occupied.

A pseudo-code depicting the functionality of the display 118 that displays the occupied seats and the unoccupied seats, in accordance with an embodiment of the present disclosure, is as follows.
a) Determine the occupied seats and the unoccupied seats in the defined space.
b) If a seat is occupied, then the value of the occupied seat is set to 1, otherwise 0.
c) The values of the occupied and unoccupied seats are fixed, and cannot be changed.
d) Display the occupied and unoccupied seat by “1” and “0” respectively.

The system 100 also contains at least one indicator which provides an indication in case any of the reserved seats are unoccupied at the commencement of journey, events, and/or the like. In an embodiment, the indicator is an LED (light emitting diode) which starts emitting red light in case if any of the reserved seats are left unoccupied. In another embodiment, the indicator starts emitting green light if all the reserved seats are occupied.

The input module 120 present in the system 100 cooperates with the handheld device 101 and accepts a choice of desired/preferred seat from the user based on the displayed seat occupancy map. In one embodiment, the structure of the input module 120 includes a receiver and a transient register. The receiver receives a selection from the user and the transient register stores the selection temporarily for further processing.

Based on the seat selection from the user, the seat locator 122 present in the system 100 cooperates with the repository 106 to identify location of the preferred seat from the stored pre-determined seat occupancy map. In one embodiment, the structure of the seat locator 110 includes a receiver and a comparator. The receiver receives the seat selection and the comparator compares it with the store seat occupancy map to identify location.

The user locator 124 is configured to cooperate with the handheld device 102 to identify location of the user. In one embodiment, the user locator 124 uses a GPS system installed in the handheld device 102 to identify user's location. In an embodiment, if the user does not choose a preferable seat, the system 100 randomly selects an available seat and identifies its location for guiding the user to that seat. In another embodiment, if the user does not choose a desired seat, the system 100 selects an available/unoccupied seat which is proximal to the user's location for guiding the user. Once the location of the seat and user location is identified, the path identifier 126 identifies at least one path from the location of the user to the location of the preferable seat. Typically, the path identifier 126 identifies paths from the user location to the seat location and selects a path from the identified paths such that the selected path is the shortest possible path with less obstacles. On identification/selection of the path by the path identifier 126, the navigator 128 navigates the user with the help of the handheld device 102 to follow the path to reach to the preferred/selected seat. In one embodiment, the navigator 128 navigates the user with help of a display of the handheld device 102 and/or audio output of the handheld device 102. The system 100, in one embodiment, includes at least one indicator (not shown in the figure) configured to indicate when all seats are occupied and/or unoccupied. The indicator can be a light emitting diode (LED) or any other light output.

A pseudo-code depicting the functionality of the navigator 128 for guiding the user to reach at the preferable seat in the defined space, is as follows:
1. Define structure of an event/vehicle/defined space by entering following details:
   name=“ABC”;
   date=“10/09/2008”;
   time=“13.20”; and
   No. of seats=100.
2. Define structure of a user, who has purchased a ticket, by entering following details:
   user name=“azm”;
   booking number=50;
3. After entering details, a display shows a pre-determined seat occupancy map. The user selects a seat using following conditions:
   switch(selection)
   Case 1: if the user confirms the purchase;
      for (i=0;i<49;i++)
      for(j=0;j<49;j++)
   Case 2: if the user has not cancel the purchase;
   Case 3: the user selects at least one seat, if seat<=seats unoccupied
4. User selects a seat on his/her own choice by:
   seats_unoccupied=seats unoccupied−choice[i][j].seats;
5. Display the seats based on the choice of the user,
   a) if(seats_unoccupied<0), then, the user does not select a seat on his/her own choice; or
   b) if(choice[i][j ].seats>seats_unoccupied)
   Display the unoccupied seat, and the users selects a seat his/her own choice.
6. If in case, the user has not selected a seat and the purchase is confirmed, then random seat is to be selected.
7. Identify at least one shortest path from the location of the user to the location of the preferable seat using following conditions:
   a) Create a path structure that includes a path for each row and column, whose minimum distance from the entrance/door is calculated. Initially, this set is empty.
   b) Assign a distance value 0 for the entrance/door.
   c) While path structure doesn't include all paths, then select a path P which is not there in the path structure and has minimum distance value. Include P to the path structure, and update distance value of P in the path structure. To update the distance values, iterate through all values of P. For each intersection point of P, if sum of distance value, is less than the distance value another point X, then update the distance value of X.

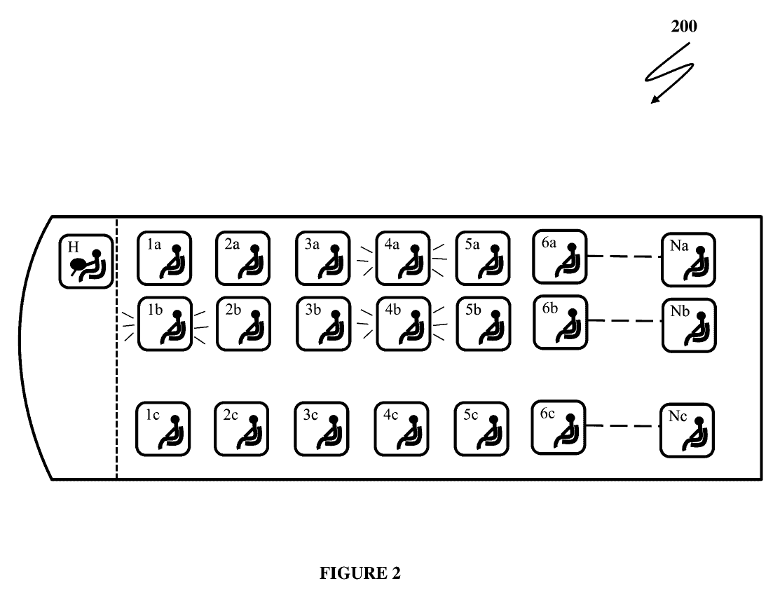

FIG. 2 illustrates a representation of the display 118. As it can be seen in FIG. 2, the darker shade indicia indicates the non-reserved seats (2a, 3c, 5b, - - - Na, Nb and Nc). The lighter shade indicia (1a, 1b, 1c - - - 6a, 6b and 6c) indicate the reserved and occupied seats. The blinking indicia (1b, 4a and 4b) indicate the reserved and un-occupied seats. After looking at the display a host H can easily identify missing users and can call them for avoiding delay.

In an exemplary embodiment, the system 100 is embedded in the defined space, where a large number of people can sit together, such as in an air bus, transport vehicle, event hall, and the like. For example, previously, an air-hostess had to do the head count to makes sure that all passengers have boarded the plane. However, with the present system 100, when the passengers occupy their respective seats in the airbus, a load cell present in their seats generates an output signal which is further amplified by the amplifier to obtain amplified signals. The amplified signals are further converted in digital signals by an analog to digital converter. The first comparator compares values of the digital signals with a stored pre-determined load value to determine the occupied seats. A second comparator further identifies reserved unoccupied seats, based on determined occupied seats and a stored seat occupancy map. Further, a display mounted on the wall of airbus displays the occupied seats and the unoccupied reserved seats, based on which the air-hostess can make further decision regarding the commencement of a flight.

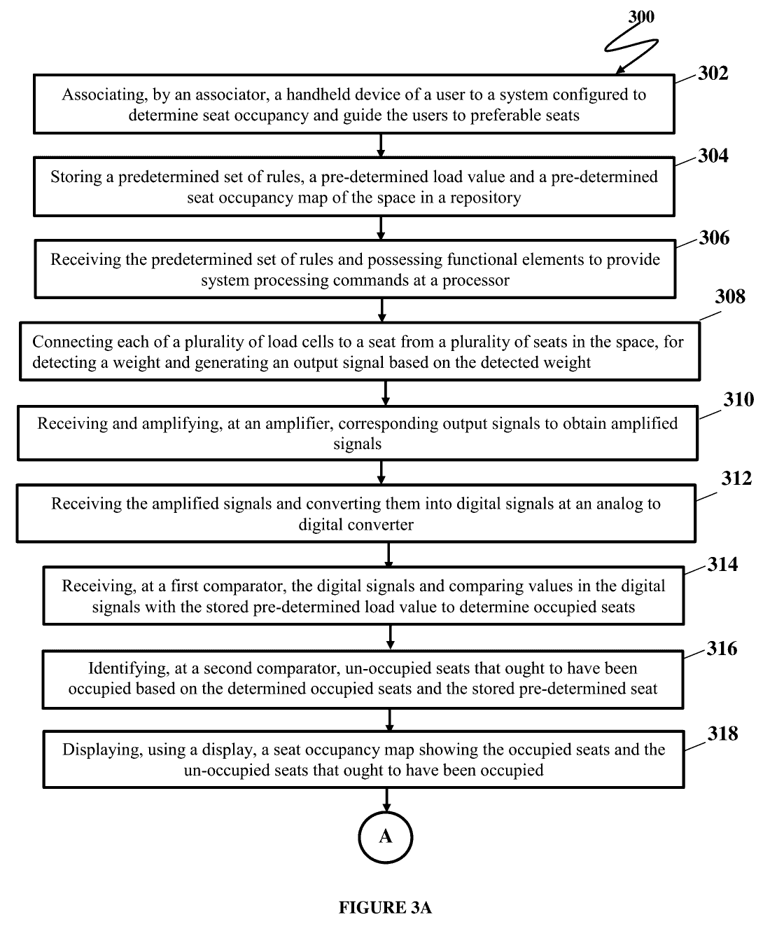

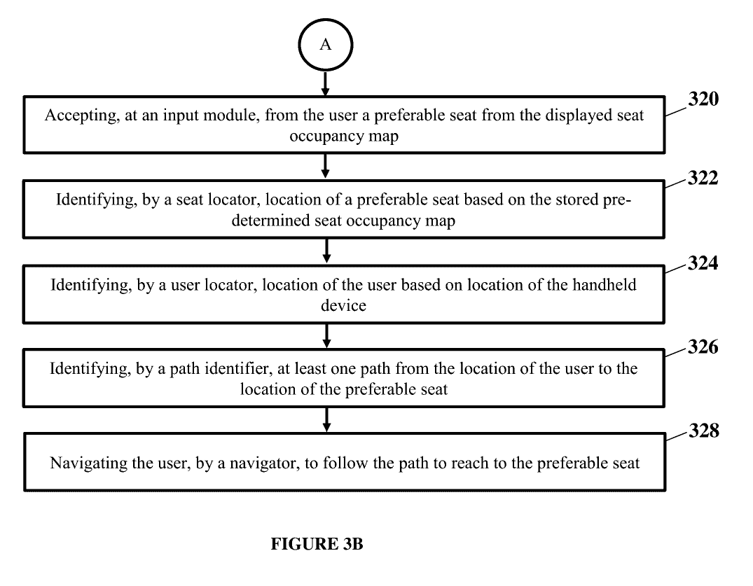

FIG. 3 illustrates a method (300) for determining the seat occupancy and guiding users with handheld devices to preferable seats in a defined space.

At block (302), a handheld device of a user to a system configured to determine seat occupancy and guide the users to preferable seats.

At block (304), storing a predetermined set of rules, a pre-determined load value and a pre-determined seat occupancy map of the space in a repository.

At block (306), receiving the predetermined set of rules and possessing functional elements to provide system processing commands at a processor.

At block (308), connecting each of a plurality of load cells to a seat from a plurality of seats in the space, for detecting a weight and generating an output signal based on the detected weight.

At block (310), receiving and amplifying, at an amplifier, corresponding output signals to obtain amplified signals.

At block (312), receiving the amplified signals and converting them into digital signals at an analog to digital converter.

At block (314), receiving, at a first comparator, the digital signals and comparing values in the digital signals with the stored pre-determined load value to determine occupied seats.

At block (316), identifying, at a second comparator, un-occupied seats that ought to have been occupied based on the determined occupied seats and the stored pre-determined seat occupancy map.

At block (318), displaying, using a display, a seat occupancy map showing the occupied seats and the un-occupied seats that ought to have been occupied.

At block (320), accepting, at an input module, from the user a preferable seat from the displayed seat occupancy map.

At block (322), identifying, by a seat locator, location of a preferable seat based on the stored pre-determined seat occupancy map.

At block (324), identifying, by a user locator, location of the user based on location of the handheld device.

At block (326), identifying, by a path identifier, at least one path from the location of the user to the location of the preferable seat.

At block (328), navigating the user, by a navigator, to follow the path to reach to the preferable seat

In one embodiment, the step of identifying at least on path includes a step of identifying a path with less obstacles. In another embodiment, the step of displaying the seat occupancy map includes displaying occupied seats and unoccupied seats, such that the occupied seats have different indicia than the unoccupied seats. Further, the method (300) includes a step of identifying an unoccupied seat from the stored seat occupancy map such that location of the identified unoccupied seat is proximal to a user location and a path from the user location to the location of the unoccupied seat has less obstacles. Additionally, the method (300) includes a step of providing an indication when all seats are occupied and/or unoccupied.

### Technical Advancements

The technical advancements offered by the present disclosure include the realization of a computer implemented system and method for determining seat occupancy and guiding users to preferable seats in a defined space, which:
determines the seat occupancy in a defined space;
reduces human errors while determining the seat occupancy;
guides users to seats in a defined space;
guides users to seats by paths having less obstacles; and
guides users to seats with the help of handheld devices.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A computer implemented system for determining seat occupancy and guiding users with handheld devices to preferable seats in a defined space, said system comprising:
an associator configured to associate a handheld device of a user to said system;
a repository configured to store a predetermined set of rules, a pre-determined load value, and a pre-determined seat occupancy map of said space;
a processor configured to cooperate said repository to receive said rules and possessing functional elements to provide system processing commands;
a plurality of load cells, each load cell connected to a seat from a plurality of seats in said space, and configured to detect a weight and generate an output signal based on the detected weight;
an amplifier configured to cooperate with said processor and said load cells, to respectively receive said processing commands and output signals, and further configured to amplify said output signals to obtain amplified signals;
an analog to digital converter configured to cooperate with said processor and said amplifier, to respectively receive the processing commands and the amplified signals, and further configured to convert the amplified signals into digital signals;
a first comparator configured to cooperate with said processor, said repository and the analog to digital converter, to respectively receive the processing commands, the pre-determined load value, and the digital signals, and further configured to compare values in the digital signals with the stored pre-determined load value to determine occupied seats;
a second comparator configured to cooperate with said processor, said repository and said first comparator, to respectively receive the processing commands, the seat occupancy map, and the determined occupied seats, and further configured to identify un-occupied seats that ought to have been occupied, based on the determined occupied seats and the stored pre-determined seat occupancy map;
a display configured to cooperate with said processor, said first comparator and said second comparator, to respectively receive the processing commands, the determined occupied seats, and the un-occupied seats that ought to have been occupied, and further configured to display a seat occupancy map showing the occupied seats and the un-occupied seats that ought to have been occupied;
an input module configured to cooperate with said display and said handheld device to accept from the user a preferable seat from the displayed seat occupancy map;
a seat locator configured to cooperate with said input module and said repository to identify location of the preferable seat based on the stored pre-determined seat occupancy map;
a user locator configured to cooperate with said handheld device to identify location of the user;
a path identifier configured to cooperate with said seat locator and said user locator to identify at least one path from the location of the user to the location of the preferable seat; and
a navigator configured to cooperate with said path identifier and said display to navigate the user to follow said path to reach to said preferable seat.

2. The system as claimed in claim 1, which includes at least one indicator configured to provide indication when all seats are occupied and/or unoccupied.

3. The system as claimed in claim 1, wherein said display displays the seat occupancy map such that the occupied seats and the un-occupied seats have different indicia.

4. The system as claimed in claim 1, wherein said load cells are selected from a group of load cells consisting of strain gauge load cells and piezoelectric load cells.

5. The system as claimed in claim 2, wherein said indicator is a light emitting diode (LED).

6. The system as claimed in claim 1, wherein said path identifier identifies a path such that said path has less obstacles.

7. The system as claimed in claim 1, wherein said seat locator is configured to identify an unoccupied seat from the stored seat occupancy map such that location of the identified unoccupied seat is proximal to a user location and a path from the user location to the location of the unoccupied seat has less obstacles.

8. The system as claimed in claim 1, wherein said repository stores a seat reservation map, and said system is configured to provide indication when said seat occupancy map does not match said seat reservation map.

9. A computer implemented method for determining seat occupancy and guiding users with handheld devices to preferable seats in a defined space, said method comprising the following:
associating, by an associator, a handheld device of a user to a system configured to determine seat occupancy and guide said users to preferable seats;
storing a predetermined set of rules, a pre-determined load value and a pre-determined seat occupancy map of said space in a repository;
receiving the predetermined set of rules and possessing functional elements to provide system processing commands at a processor;
connecting each of a plurality of load cells to a seat from a plurality of seats in said space, for detecting a weight and generating an output signal based on the detected weight;
receiving and amplifying, at an amplifer, corresponding output signals to obtain amplified signals;
receiving the amplified signals and converting them into digital signals at an analog to digital converter;
receiving, at a first comparator, the digital signals and comparing values in the digital signals with the stored pre-determined load value to determine occupied seats;
identifying, at a second comparator, un-occupied seats that ought to have been occupied based on the determined occupied seats and the stored pre-determined seat occupancy map;
displaying, using a display, a seat occupancy map showing the occupied seats and the un-occupied seats that ought to have been occupied;
accepting, at an input module, from the user a preferable seat from the displayed seat occupancy map;
identifying, by a seat locator, location of a preferable seat based on the stored pre-determined seat occupancy map;
identifying, by a user locator, location of the user based on location of the handheld device;
identifying, by a path identifier, at least one path from the location of the user to the location of the preferable seat; and
navigating the user, by a navigator, to follow said path to reach to said preferable seat.

10. The method as claimed in claim 9, which includes said step of providing indication includes a step of using a light emitting diode (LED) as an indicator, and further includes a step of providing indication when all seats are occupied and/or unoccupied.

11. The method as claimed in claim 9, wherein said step of displaying includes displaying the seat occupancy map such that the occupied seats and the un-occupied seats have different indicia.

12. The method as claimed in claim 9, wherein said load cells are selected from a group of load cells consisting of strain gauge load cells and piezoelectric load cells.

13. The method as claimed in claim 9, wherein said step of identifying at least on path includes a step of identifying a path with less obstacles.

14. The method as claimed in claim 9, which includes step of identifying the unoccupied seat from the stored seat occupancy map such that location of the identified unoccupied seat is proximal to a user location and a path from the user location to the location of the unoccupied seat has less obstacles.

15. The system as claimed in claim 1, wherein said step of storing also includes a step of storing a seat reservation map, and said step of storing the seat reservation map provides indication when said seat occupancy map does not match said seat reservation map.
